(19) United States
(12) Patent Application Publication
(10) Pub. No.: US 2026/0156232 A1
(43) Pub. Date: Jun. 4, 2026

(54) PROJECTION DEVICE AND DRIVE CIRCUIT MODULE THEREOF

(71) Applicant: Coretronic Corporation, Hsin-Chu (TW)

(72) Inventors: Chia-Wen Hsu, Hsin-Chu (TW); Tung-Min Lee, Hsin-Chu (TW); Ying-Chieh Yeh, Hsin-Chu (TW)

(73) Assignee: Coretronic Corporation, Hsin-Chu (TW)

(21) Appl. No.: 19/392,048

(22) Filed: Nov. 17, 2025

(30) Foreign Application Priority Data
Dec. 3, 2024 (CN) 202411759955.5

(51) Int. Cl. H04N 9/31; H05B 45/34

(52) U.S. Cl. CPC H04N 9/3138; H04N 9/3155; H04N 9/3161; H04N 9/3164; H04N 9/3197; H05B 45/34

(57) ABSTRACT

A projection device and a drive circuit module thereof are provided. A power supply unit provides a drive voltage to an output end. A bypass circuit is coupled between the output end and a ground end of the power supply unit. In response to the power supply unit stopping to provide the drive voltage, the bypass circuit provides a discharge path for electrical energy of the output capacitor to discharge and stores part of the electrical energy from the output capacitor, allowing a voltage value at the output end of the power supply unit to decrease to a first voltage value. The first voltage value is lower than a minimum operating voltage value. The projection device and the drive circuit module thereof provided may optimize the turn-on and turn-off time of the light source unit of the projection device, thereby improving the display quality of the projection device.

### CROSS-REFERENCE TO RELATED APPLICATION

This application claims the priority benefit of China application serial no. 202411759955.5 filed on Dec. 3, 2024. The entirety of the above-mentioned patent application is hereby incorporated by reference herein and made a part of this specification.

### BACKGROUND

### Technical Field

The disclosure relates to a display device, and particularly relates to a projection device and a drive circuit module thereof.

### Description of Related Art

In general, the output end of a light source driving circuit in a projection device includes an output inductor and an output capacitor. One end of the output capacitor is connected to the output end, and the other end is grounded. The output capacitor stores energy, releases energy, and filters, thereby providing a stable output voltage to the light source unit. Since the inductor and capacitor elements are energy storage elements, even when the light source driving circuit is turned off, its residual energy will still be sent to the light source unit until the energy is exhausted, resulting in an excessively large delay between the actual turn-off time point of the light source unit and the turn-off time point of the light source driving circuit. The light source unit cannot be turned off immediately, which may easily cause color abnormalities in the projected image of the projection device.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the disclosure was acknowledged by a person of ordinary skill in the art.

### SUMMARY

The disclosure provides a projection device and a drive circuit module thereof, which may optimize the turn-on and turn-off time of the light source unit of the projection device, thereby improving the display quality of the projection device.

Other objects and advantages of the disclosure may be further understood from the technical features disclosed herein.

In order to achieve one or a part or all of the above or other objects, the drive circuit module of the disclosure is configured to drive a light source unit, the light source unit has a minimum operating voltage value, and the drive circuit module includes a power supply unit and a bypass circuit. The power supply unit has an output end and a ground end, and includes an output capacitor, the output capacitor is coupled between the output end and the ground end of the power supply unit, the output end of the power supply unit is coupled to the light source unit, and the power supply unit is configured to provide a drive voltage to the output end. The bypass circuit is coupled between the output end and the ground end of the power supply unit. In response to the power supply unit stopping to provide the drive voltage, the bypass circuit provides a discharge path for electrical energy of the output capacitor to discharge and stores part of the electrical energy from the output capacitor, allowing a voltage value at the output end of the power supply unit to decrease to a first voltage value. The first voltage value is lower than the minimum operating voltage value.

The disclosure further provides a projection device, which includes an illumination system, a light valve, and a projection lens. The illumination system is configured to provide an illumination light beam. The illumination system includes a light source unit and a drive circuit module, the drive circuit module is configured to drive the light source unit to allow the light source unit to provide at least one light beam, the illumination light beam includes the at least one light beam, and the light source unit has a minimum operating voltage value. The drive circuit module includes a power supply unit and a bypass circuit. The power supply unit has an output end and a ground end, and includes an output capacitor, the output capacitor is coupled between the output end and the ground end of the power supply unit, the output end of the power supply unit is coupled to the light source unit, and the power supply unit is configured to provide a drive voltage to the output end. The bypass circuit is coupled between the output end and the ground end of the power supply unit. In response to the power supply unit stopping to provide the drive voltage, the bypass circuit provides a discharge path for electrical energy of the output capacitor to discharge and stores part of the electrical energy from the output capacitor, allowing a voltage value at the output end of the power supply unit to decrease to a first voltage value. The first voltage value is lower than the minimum operating voltage value. The light valve is disposed on a transmission path of the illumination light beam and is configured to convert the illumination light beam into an image light beam. The projection lens is disposed on a transmission path of the image light beam and is configured to project the image light beam out of the projection device.

Based on the above, the bypass circuit in the embodiment of the disclosure reacts to the power supply unit stopping to provide the drive voltage, provides a discharge path for the electrical energy of the output capacitor to discharge and stores part of the electrical energy from the output capacitor, thereby decreasing the voltage value at the output end to a voltage value below the minimum operating voltage value of the light source unit. In this way, in response to the power supply unit stopping to provide the drive voltage, the output end voltage of the drive circuit module is quickly adjusted to an appropriate voltage to optimize the turn-on and turn-off time of the light source unit of the projection device, thereby improving the display quality of the projection device.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

FIG. 1 is a block diagram of the projection device according to the embodiment of the disclosure.

FIG. 2 and FIG. 3 are schematic diagrams of the drive circuit module and the light source unit in the illumination system according to the embodiment of the disclosure.

FIG. 4A is a schematic diagram of the circuit operation state of the drive circuit module according to the embodiment of the disclosure.

FIG. 4B is a waveform diagram of the switch operation, output voltage, and output current of the drive circuit module according to the embodiment of the disclosure.

FIG. 5A is another circuit operation state of the drive circuit module according to the embodiment of the disclosure.

FIG. 5B is another waveform diagram of the switch operation, output voltage, and output current of the drive circuit module according to the embodiment of the disclosure.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described.

The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Unless limited otherwise, the terms “connected,” “coupled,” and “mounted,” and variations thereof herein are used broadly and encompass direct and indirect connections, couplings, and mountings. Accordingly, the drawings and descriptions will be regarded as illustrative in nature and not as restrictive. Further, the term “signal” may refer to at least one current, voltage, charge, temperature, data, electromagnetic wave, or any other one or more signals.

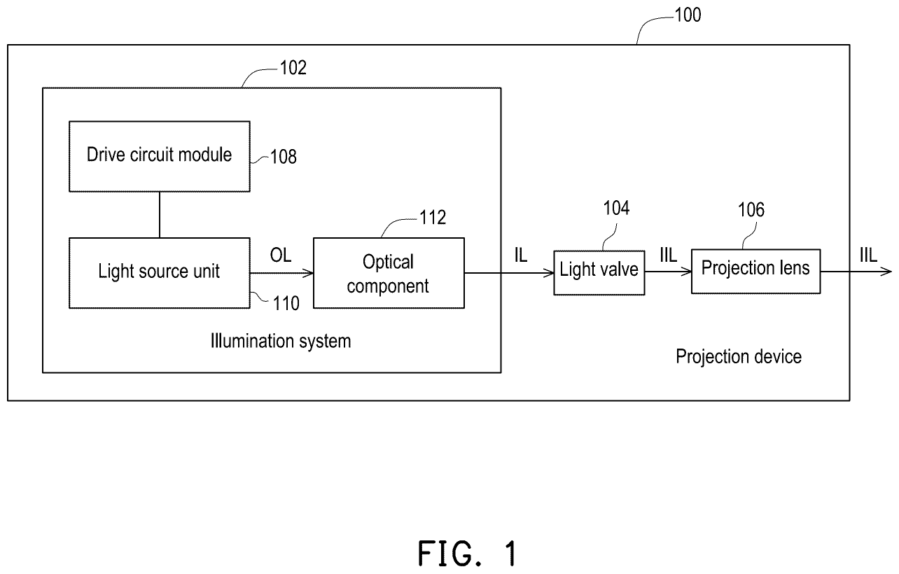

Referring to FIG. 1, which is a block diagram of the projection device according to the embodiment of the disclosure, the projection device 100 includes an illumination system 102, a light valve 104, and a projection lens 106. The illumination system 102 provides an illumination light beam IL. The light valve 104 is disposed on the transmission path of the illumination light beam IL to convert the illumination light beam IL into an image light beam IIL. The light valve 104 is, for example, a spatial light modulator such as a digital micro-mirror device (DMD), a liquid-crystal-on-silicon panel (LCOS Panel) or a liquid crystal panel. The projection lens 106 is disposed on the transmission path of the image light beam IIL and is configured to project the image light beam IIL out of the projection device 100. The projection lens 106 is, for example, one optical lens or a combination of multiple optical lenses with a diopter. The disclosure does not limit the projection lens 106 to a certain type or form. Furthermore, the illumination system 102 includes a drive circuit module 108 and a light source unit 110, with the drive circuit module 108 coupled to the light source unit 110. The drive circuit module 108 may drive the light source unit 110 to allow the light source unit 110 to provide at least one light beam OL, and the illumination light beam IL includes the at least one light beam OL provided by the light source unit 110. The light source unit 110 includes one or more light-emitting components, each of which may be, for example, a light emitting diode (LED) element or a laser diode (LD) element or a combination thereof. In the case where the light source unit 110 includes multiple light-emitting components, these components may be configured in an array.

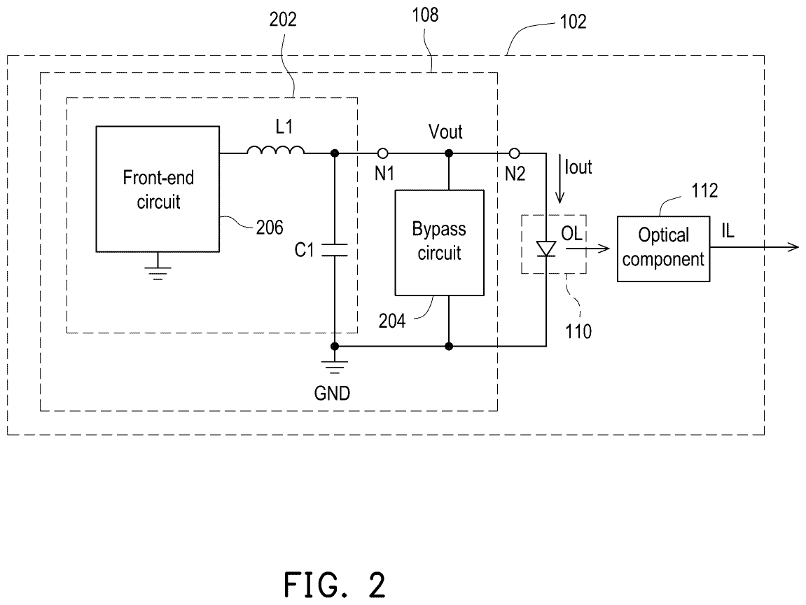

In detail, as shown in FIG. 2, the drive circuit module 108 in the illumination system 102 includes a power supply unit 202 and a bypass circuit 204. The power supply unit 202 has an output end N1 and a ground end GND, the output end N1 of the power supply unit 202 is coupled to the load connection end N2 of the drive circuit module 108, and the bypass circuit 204 is coupled between the output end N1 and the ground end GND of the power supply unit 202. The power supply unit 202 may provide a drive voltage to drive the light source unit 110 at the load connection end N2 to provide at least one light beam OL. In this embodiment, the illumination system 102 further includes an optical component 112 configured to adjust the at least one light beam OL from the light source unit 110 to form the illumination light beam IL, where the optical component 112 includes at least one or a combination of lenses, reflective elements, light-splitting elements, light-combining elements, light-homogenizing elements, wavelength conversion elements, phase modulation elements, and polarization elements. The drawings and this specification use an example where the light source unit 110 includes one light-emitting component, and the circuit and operating principle for a light source unit 110 including multiple light-emitting components are the same as those for one light-emitting component, so they will not be repeated herein.

In this embodiment, the power supply unit 202 includes a front-end circuit 206 and a back-end circuit formed by at least an output inductor L1 and an output capacitor C1, and the power supply unit 202 may be at least one of or a combination of a direct current/direct current (DC/DC) converter and an alternating current/direct current (AC/DC) converter, for example, including a buck converter, boost converter, buck-boost converter, flyback converter, LLC converter, etc., but is not limited thereto. The output inductor L1 of the power supply unit 202 is coupled between the front-end circuit 206 and the output end N1 of the power supply unit 202, and the output capacitor C1 is coupled between the output end N1 and the ground end GND of the power supply unit 202. The front-end circuit 206 provides a DC drive voltage to the light source unit 110 through the output inductor L1 and the output capacitor C1.

In response to the power supply unit 202 stopping to provide the drive voltage, the bypass circuit 204 provides a discharge path for the output capacitor C1 to discharge and stores part of the electrical energy from the output capacitor C1, allowing the voltage value Vout at the output end N1 or the load connection end N2 to quickly decrease below the minimum operating voltage value of the light source unit 110 and to a first voltage value greater than zero. Taking the light source unit 110 as one light-emitting diode for example, the minimum operating voltage value of the light source unit 110 may be, for instance, the forward voltage of the light-emitting diode. Moreover, in the case where the light source unit 110 includes a series array of N light-emitting diodes, the minimum operating voltage value would be N times the forward voltage of one light-emitting diode.

Furthermore, in response to the power supply unit 202 starting to operate and provide the drive voltage, the bypass circuit 204 may cut off the discharge path, so that the drive voltage provided by the power supply unit 202 begins to charge the output capacitor C1 and supply to the output end N1, allowing the voltage value Vout at the output end N1 to rise to a second voltage value that is greater than or equal to the minimum operating voltage value of the light source unit 110, where the second voltage value is greater than or equal to the minimum operating voltage value of the light source unit 110.

In brief, in response to the power supply unit 202 stopping to provide the drive voltage, it quickly pulls down the voltage value Vout at the output end N1, thereby shortening the time to turn off the light source unit 110, and by storing part of the electrical energy through the bypass circuit 204, it avoids directly pulling down the voltage value Vout at the output end N1 to zero, thus reducing the time required to re-enable the light source unit 110. Thus, this may effectively optimize the turn-on and turn-off times of the light source unit 110 of the projection device 100, improving the display quality of the projection device 100. It is noted that the “turn-off time” mentioned in this specification refers to the time difference from when the power supply unit 202 stops providing the drive voltage to when the light source unit 110 actually turns off, and the “turn-on time” refers to the time difference from when the power supply unit 202 starts providing the drive voltage to when the light source unit 110 actually turns on.

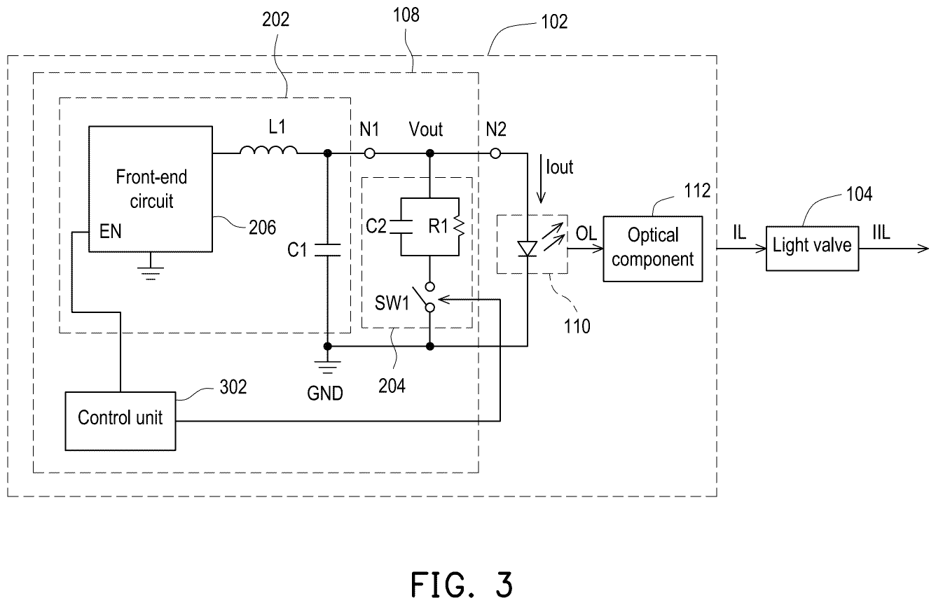

Referring to FIG. 3, in an embodiment of the disclosure, the drive circuit module 108 further includes a control unit 302, and the bypass circuit 204 includes a bypass capacitor C2, a bypass resistor R1, and a bypass switch SW1. The control unit 302 is coupled not only to the enable end EN of the front-end circuit 206 located in the power supply unit 202, but also to the bypass switch SW1 of the bypass circuit 204 to transmit control signals to control a conduction state of the bypass switch SW1, the control signals correspond to enable signals, and the control unit 302 enables or disables the operation of the front-end circuit 206 by outputting enable signals to the enable end EN of the front-end circuit 206. The bypass capacitor C2 is connected in parallel with the bypass resistor R1, and in series with the bypass switch SW1 between the output end N1 of the power supply unit 202 and the ground end GND. In some embodiments, within the bypass circuit 204, the positions of the parallel-connected bypass capacitor C2 and bypass resistor R1 may be interchanged with the bypass switch SW1, and are not limited to the embodiment shown in FIG. 3.

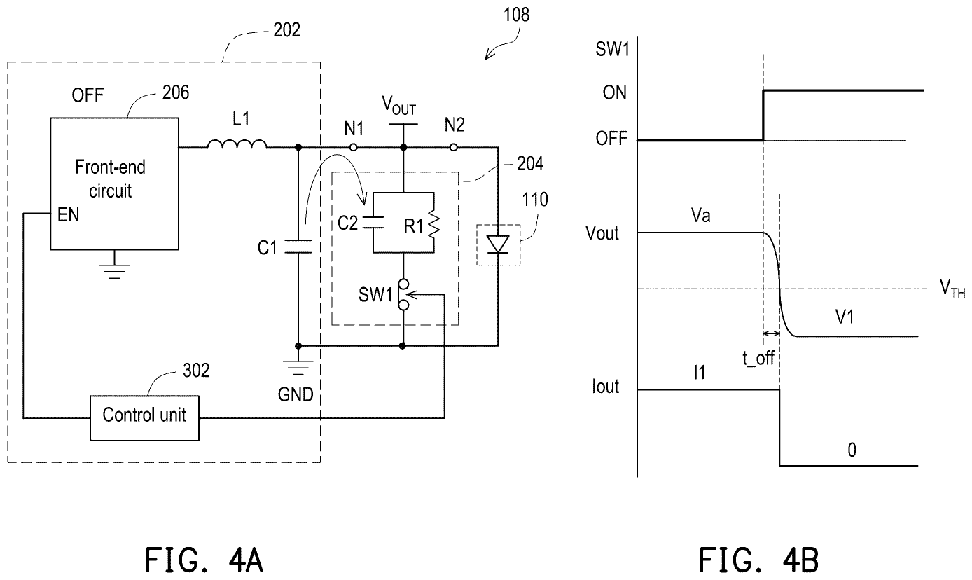

Referring to FIG. 4A and FIG. 4B, in the case where the enable signal provided by the control unit 302 is to control the front-end circuit 206 to stop operating, the control unit 302 simultaneously provides a control signal to the bypass switch SW1 according to the enable signal to control the bypass switch SW1 to turn on (ON). For example, the bypass switch SW1 may be turned on simultaneously with or after the enable signal switches to a closing signal. In response to the bypass switch SW1 being turned on, the output capacitor C1 and the bypass capacitor C2 form a parallel circuit, and the electrical energy of the output capacitor C1 is distributed to the bypass capacitor C2, allowing the bypass capacitor C2 to store part of the electrical energy released by the output capacitor C1, thereby decreasing the voltage value Vout at the output end N1 to below the minimum operating voltage value within the turn-off time t_off. The capacitance value of the bypass capacitor C2 should meet the following Condition Expression (1).

$$\frac{C 2}{( C 2 + C 1 )} Vo < {V}_{TH} \qquad ( 1 )$$

Where Vo is the rated output voltage value of the power supply unit 202, V_{TH} is the minimum operating voltage value of the light source unit 110.

$$( \frac{C 2}{( C 2 + C 1 )} Vo )$$

is the voltage value at the output end N1 after the bypass switch SW1 is turned on and the electrical energy distribution between the output capacitor C1 and the bypass capacitor C2 is completed. In other words, Condition Expression (1) is to ensure that after the bypass switch SW1 is turned on, the voltage value Vout at the output end N1 may be quickly pulled down below the minimum operating voltage value of the light source unit 110.

For example, in the first design case of the drive circuit module 108, the rated output voltage value Vo of the power supply unit 202 is 5V, and the minimum operating voltage value V_{TH} of the light source unit 110 is 3.5V. According to Condition Expression (1), the capacitance value of the bypass capacitor C2 should be less than 7/3 times the capacitance value of the output capacitor C1 to achieve the purpose of closing the light source unit 110. In this example, the capacitance values of the output capacitor C1 and the bypass capacitor C2 are taken to be equal, i.e., C1=C2. After the bypass switch SW1 is turned on, the voltage value Vout at the output end N1 is decreased from the voltage value Va (for example, the rated output voltage value Vo=5V) to the first voltage value

$$V 1 = \frac{C 2}{( C 2 + C 1 )} V 1 = \frac{1}{2} V 1 = 2.5 V .$$

The first voltage value V1 is lower than the minimum operating voltage value V_{TH}=3.5V, the output current Iout provided to the light source unit 110 is decreased from the current value I1 to zero, and the light source unit 110 is switched to the turned-off state.

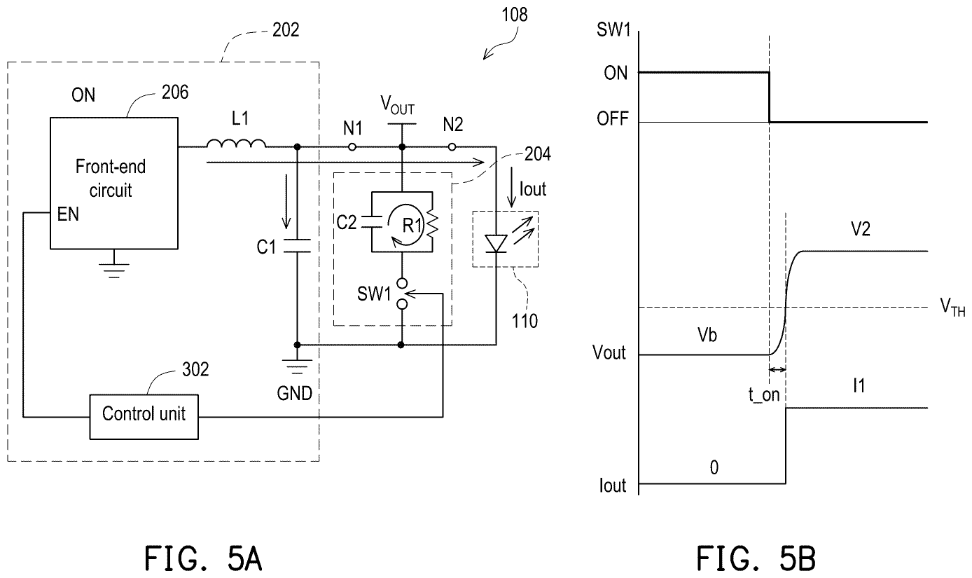

Referring to FIG. 5A and FIG. 5B, furthermore, when the enable signal provided by the control unit 302 is to control the front-end circuit 206 to start operating, the control unit 302 provides a control signal to the bypass switch SW1 according to the enable signal to control the bypass switch SW1 to turn off (OFF) and cut off the discharge path. For example, the bypass switch SW1 is turned off simultaneously with or after the enable signal is switched to a starting signal, the front-end circuit 206 supplies power to the output end N1 through the output inductor L1 and the output capacitor C1, and charges the output capacitor C1, the voltage value Vout at the output end N1 rises from the voltage value Vb to the second voltage value V2, the voltage value Vout at the output end N1 rises to be greater than or equal to the minimum operating voltage value V_{TH} of the light source unit 110 within the turn-on time t_on, and the light source unit 110 starts up. At the same time, the bypass resistor R1 allows the bypass capacitor C2 to discharge, depleting the electrical energy stored in the bypass capacitor C2, so that the output capacitor C1 may store some electrical energy in response to the bypass switch SW1 being turned on again.

Since when the front-end circuit 206 stops operating, the voltage value Vout at the output end N1 is pulled down to the first voltage value V1 which is lower than the minimum operating voltage value V_{TH}, but not pulled down to zero, in response to the light source unit 110 being turned on again, it is not necessary to start from zero to pull up the voltage value Vout at the output end N1 to the second voltage value V2 which is greater than or equal to the minimum operating voltage value V_{TH}, to start the light source unit 110 and provide current Iout with current value I1, quickly switching the light source unit 110 to the operation state of providing light beam OL, thus effectively reducing the turn-on time of the light source unit 110.

The resistance value of the bypass resistor R1 determines the discharge time of the bypass capacitor C2. Since the bypass capacitor C2 should complete discharging within the turn-off interval duration (turn-off time) t_off of the light source unit 110, the discharge time of the bypass capacitor C2 to the bypass resistor R1 should at least comply with the following equation (2).

$$t\_off = 5 R 1 \times C 2 \qquad ( 2 )$$

For example, in the second design case of the drive circuit module, the set switching frequency of the light source unit 110 is set to 120 Hz, with a duty cycle of 33%, so that the turn-off interval duration t_off of the light source unit 110 is

$$\frac{1}{120} \times ( 1 - 33 \% ) = 5.583 ms .$$

Assuming C1=4.7 uF, C2=2.2 uF, the bypass resistor R1 should be

$$\frac{5.583 ms}{5 \times 2.2 uF} = 507 Ω ,$$

so the bypass resistor R1 may be set to 510 ohms.

The values of the output capacitor C1, bypass capacitor C2, and bypass resistor R1 mentioned above are only exemplary embodiments, and the values of the output capacitor C1, bypass capacitor C2, and bypass resistor R1 may be adjusted according to actual requirements and are not limited to the above embodiments. For example, the capacitance values of the output capacitor C1 and bypass capacitor C2 may be adjusted based on the minimum operating voltage value V_{TH}, and by adjusting the capacitance values of the output capacitor C1 and bypass capacitor C2, the energy distribution between the output capacitor C1 and bypass capacitor C2 may be adjusted to pull down the output voltage Vout to a voltage value less than the minimum operating voltage value V_{TH} but greater than zero.

In summary, the bypass circuit 204 of the drive circuit module 108 of the disclosure reacts to the power supply unit 108 stopping to provide the drive voltage, provides a discharge path for the electrical energy of the output capacitor C1 to discharge and stores part of the electrical energy from the output capacitor C1, thereby rapidly decreasing the voltage value at the output end N1 to below the minimum operating voltage value of the light source unit 110, thus instantly turning off the light source unit 110. Furthermore, in response to the power supply unit 108 starting to provide the drive voltage, it may also shorten the time for the voltage at the output end N1 to increase above the minimum operating voltage value by avoiding decreasing the voltage at the output end N1 to zero voltage, thereby instantly turning on the light source unit 110, achieving the purpose of optimizing the turn on and turn off time of the light source unit of the projection device, and improving the display quality of the projection device.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The use of “at least one of . . . and . . . ” thereof herein may include “one or more of the items contained in the list”. For example, the use of “at least one of A and B” thereof herein may include only A, or only B, or A and B. Similarly, the use of “at least one of A, B, and C” thereof herein may include only A, or only B, or only C, or any combination of A, B, and C. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A drive circuit module, configured to drive a light source unit, the light source unit having a minimum operating voltage value, and the drive circuit module comprising a power supply unit and a bypass circuit, wherein:
the power supply unit has an output end and a ground end, and comprises an output capacitor, the output capacitor is coupled between the output end and the ground end, the output end is coupled to the light source unit, and the power supply unit is configured to provide a drive voltage to the output end; and
the bypass circuit is coupled between the output end and the ground end;
wherein in response to the power supply unit stopping to provide the drive voltage, the bypass circuit provides a discharge path for electrical energy of the output capacitor to discharge and stores part of the electrical energy from the output capacitor, allowing a voltage value at the output end to decrease to a first voltage value;
the first voltage value is lower than the minimum operating voltage value.

2. The drive circuit module according to claim 1, wherein
the first voltage value is greater than zero;
in response to the power supply unit starting to provide the drive voltage, the bypass circuit stops providing the discharge path, the drive voltage of the power supply unit charges the output capacitor, allowing the voltage value at the output end to rise to a second voltage value; and
the second voltage value is greater than or equal to the minimum operating voltage value.

3. The drive circuit module according to claim 1, wherein the bypass circuit comprises a bypass capacitor, a bypass resistor, and a bypass switch, wherein:
the bypass capacitor is connected in parallel with the bypass resistor, and is connected in series with the bypass switch between the output end and the ground end.

4. The drive circuit module according to claim 2, wherein the bypass circuit comprises a bypass capacitor, a bypass resistor, and a bypass switch, wherein:
the bypass capacitor is connected in parallel with the bypass resistor, and is connected in series with the bypass switch between the output end and the ground end.

5. The drive circuit module according to claim 3, wherein
in response to the power supply unit stopping to provide the drive voltage, the bypass switch turns on to form the discharge path, and the bypass capacitor allows the output capacitor to discharge and stores part of the electrical energy from the output capacitor; and
in response to the power supply unit starting to provide the drive voltage, the bypass switch turns off and cut off the discharge path, and the bypass resistor allows the bypass capacitor to discharge.

6. The drive circuit module according to claim 3, wherein a capacitance value C2 of the bypass capacitor satisfies:
$$\frac{C 2}{( C 2 + C 1 )} Vo < {V}_{TH}$$
where C1 is a capacitance value of the output capacitor, Vo is a rated output voltage value of the power supply unit, and V_{TH} is the minimum operating voltage value of the light source unit.

7. The drive circuit module according to claim 3, wherein the drive circuit module comprises a control unit, wherein:
the control unit is coupled to the power supply unit and the bypass switch, wherein the control unit correspondingly controls a conduction state of the bypass switch according to an enable signal provided to the power supply unit.

8. The drive circuit module according to claim 7, wherein the enable signal provided by the control unit allows the power supply unit to stop providing the drive voltage, or allows the power supply unit to start providing the drive voltage.

9. A projection device, the projection device comprising an illumination system, a light valve, and a projection lens, wherein:
the illumination system is configured to provide an illumination light beam, wherein the illumination system comprises a light source unit and a drive circuit module, the drive circuit module is configured to drive the light source unit to allow the light source unit to provide at least one light beam, the illumination light beam comprises the at least one light beam, and the light source unit has a minimum operating voltage value; the drive circuit module comprises a power supply unit and a bypass circuit, wherein:
the power supply unit has an output end and a ground end, and comprises an output capacitor, the output capacitor is coupled between the output end and the ground end, the output end is coupled to the light source unit, and the power supply unit is configured to provide a drive voltage to the output end;
the bypass circuit is coupled between the output end and the ground end;
in response to the power supply unit stopping to provide the drive voltage, the bypass circuit provides a discharge path for electrical energy of the output capacitor to discharge and stores part of the electrical energy from the output capacitor, allowing a voltage value at the output end to decrease to a first voltage value;
the first voltage value is lower than the minimum operating voltage value;
the light valve is disposed on a transmission path of the illumination light beam and is configured to convert the illumination light beam into an image light beam; and
the projection lens is disposed on a transmission path of the image light beam and is configured to project the image light beam out of the projection device.

10. The projection device according to claim 9, wherein
the first voltage value is greater than zero;
in response to the power supply unit starting to provide the drive voltage, the bypass circuit stops providing the discharge path, the drive voltage of the power supply unit charges the output capacitor, allowing the voltage value at the output end to rise to a second voltage value; and
the second voltage value is greater than or equal to the minimum operating voltage value.

11. The projection device according to claim 9, wherein the bypass circuit comprises a bypass capacitor, a bypass resistor, and a bypass switch, wherein:
the bypass capacitor is connected in parallel with the bypass resistor, and is connected in series with the bypass switch between the output end and the ground end.

12. The projection device according to claim 10, wherein the bypass circuit comprises a bypass capacitor, a bypass resistor, and a bypass switch, wherein:
the bypass capacitor is connected in parallel with the bypass resistor, and is connected in series with the bypass switch between the output end and the ground end.

13. The projection device according to claim 11, wherein
in response to the power supply unit stopping to provide the drive voltage, the bypass switch turns on to form the discharge path, and the bypass capacitor allows the output capacitor to discharge and stores part of the electrical energy from the output capacitor; and
in response to the power supply unit starting to provide the drive voltage, the bypass switch turns off and cut off the discharge path, and the bypass resistor allows the bypass capacitor to discharge.

14. The projection device according to claim 11, wherein
a capacitance value C2 of the bypass capacitor satisfies:
$$\frac{C 2}{( C 2 + C 1 )} Vo < {V}_{TH}$$
where C1 is a capacitance value of the output capacitor, Vo is a rated output voltage value of the power supply unit, and V_{TH} is the minimum operating voltage value of the light source unit.

15. The projection device according to claim 11, wherein the drive circuit module further comprises a control unit, wherein:
the control unit is coupled to the power supply unit and the bypass switch, wherein the control unit correspondingly controls a conduction state of the bypass switch according to an enable signal provided to the power supply unit.

16. The drive circuit module according to claim 15, wherein the enable signal provided by the control unit allows the power supply unit to stop providing the drive voltage, or allows the power supply unit to start providing the drive voltage.
